(19) United States
(12) Patent Application Publication
(10) Pub. No.: US 2013/0176001 A1
(43) Pub. Date: Jul. 11, 2013

(54) METHOD FOR CHARGING A BATTERY OF A MOTOR VEHICLE

(71) Applicant: Reinhard Hofmann, Kipfenberg (DE)

(72) Inventor: Reinhard Hofmann, Kipfenberg (DE)

(73) Assignee: AUDI AG, Ingolstadt (DE)

(21) Appl. No.: 13/823,605

(22) PCT Filed: Sep. 9, 2011
(86) PCT No.: PCT/EP2011/004543

§ 371 Date: Mar. 14, 2013

(30) Foreign Application Priority Data
Sep. 15, 2010 (DE) 10 2010 045 515.6

(51) Int. Cl. H02J 7/00

(52) U.S. Cl. CPC H02J 7/0052
USPC 320/162

(57) ABSTRACT

In a method for charging a battery of a motor vehicle, with the battery having a plurality of electrochemical cells, all electrochemical cells are charged with a predefined charge current over a predefined charge time, when the battery is charged for the first time. After the first-time charging, a battery state of each electrochemical cell is determined, with a deviation from a target charge state being stored for each cell. Thereafter, the cells are then balanced. In subsequent charging processes, a charge current and/or charge time for future charging processes is determined for each electrochemical cell in dependence on the stored deviation from the target charge state following the first-time charging. Charge currents and charge times for individual cells are adjusted in this manner to the specific properties thereof such that an optimal charge state of the battery is ensured without the need for separate balancing in subsequent charging processes.

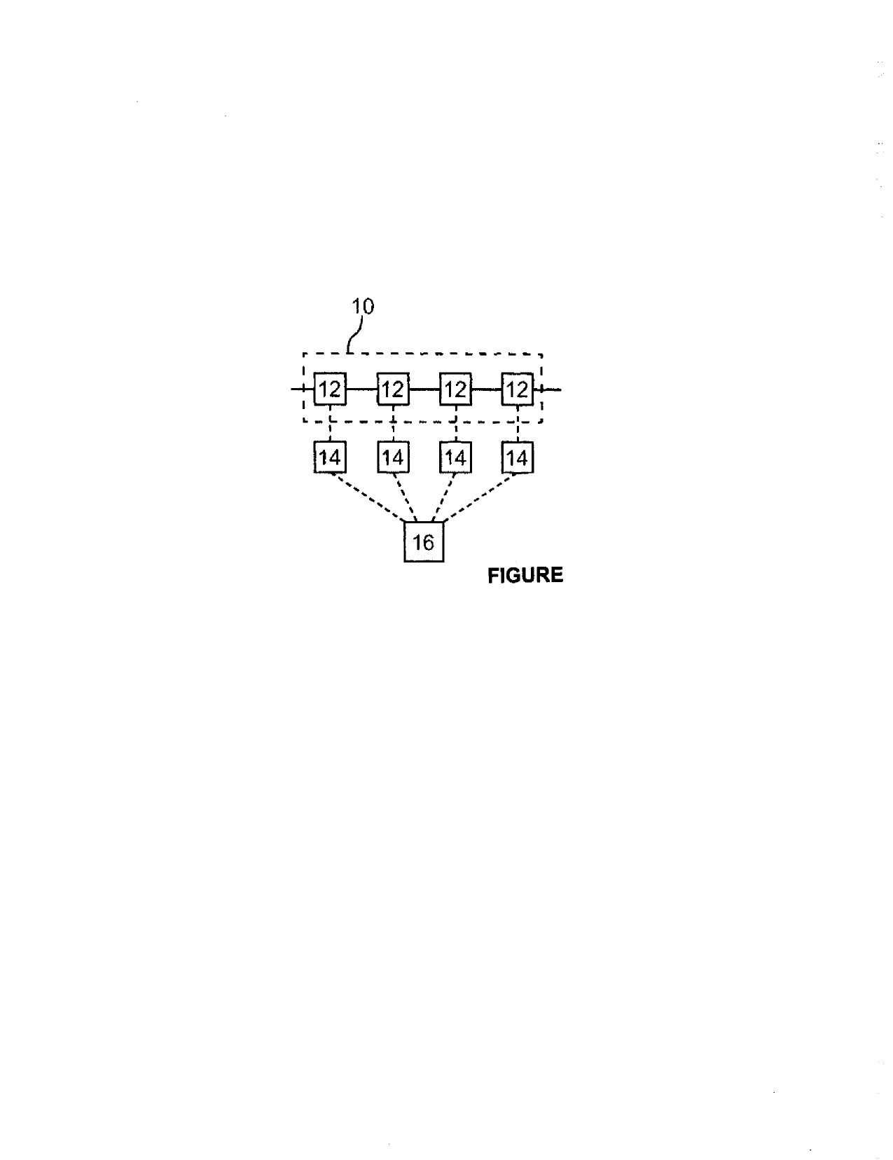

The invention relates to a method for charging a battery of a motor vehicle, with the battery having a plurality of electrochemical cells.

Due to manufacturing tolerances and the like, the individual electrochemical cells of such batteries frequently differ slightly in their properties. The cells thus charge and discharge to varying degrees when exposed to same stress. It is therefore necessary to perform a so-called balancing following the charging processes. The charge states of the individual electrochemical cells are hereby compared with respective target charge states. When the charge of a cell exceeds the target charge state, the cell is partially discharged again until its charge corresponds to the desired value. Conversely, cells with a charge below the target charge state are further charged until reaching the target charge state. Ideally, the electrical energy stored in the excessively charged cells is used to further charge insufficiently charged cells. A drawback of known balancing processes is that they take place only after the individual cells have been completely charged. This can result in overcharging of individual cells so that their service life is reduced. At the same time, balancing prolongs the charging process.

US 2010/0109610 A1 discloses a method in which a balancing of the individual cells takes place already during the charging process. Charging phases, balancing phases and uncharged measurement phases alternate hereby. In this way, overcharging of individual cells is avoided. The frequent change between the individual phases of the charging process prolongs, however, also the charging process.

The present invention is therefore based on the object to provide a method of the afore-mentioned type which enables an especially rapid charging of electrochemical cells of a battery of a motor vehicle while at the same time allowing balancing of charge.

This object is attained by a method having the features of patent claim 1.

In a method according to the invention, first-time charging of a battery involves a charging of all electrochemical cells of the battery with a predefined charge current for a predefined charge time. Subsequently, a charge state of each electrochemical cell is determined, and for each cell a deviation from a target charge state is stored. Thereafter, the cells are balanced. The stored deviations for the respective charge states of the individual cells is used to adjust the charge current and/or charge time for each electrochemical cell in subsequent charging processes. This adjustment ensures that during subsequent charging processes all cells are already as close as possible to their target charge state after charging so that the need for balancing is eliminated. The method therefore allows an especially quick and efficient charging of a battery in the absence of any risk of overcharging individual cells. Oftentimes, balancing has to be carried out only during the first charging process.

As the necessary charge currents or charge times for individual cells may change with age, it may be suitable to determine the charge state of each electrochemical cell after each subsequent charging process and to store a deviation from a target charge state again for each cell. When these deviations exceed predefined limit values, balancing is executed also after the subsequent charging process. This ensures that even aging batteries have reached their optimal charge state after each charging process.

According to a particularly preferred embodiment of the invention, the thus-determined deviations form the basis for executing during subsequent charging processes again an adjustment of the charge current and/or the charge time for future charging process. The charge parameters of the battery are thus constantly refined iteratively so that the need for balancing operations can be substantially eliminated while ensuring an optimum charge state at any time.

Preferably, the charge current and/or the charge time for an electrochemical cell having a charge state which exceeds after a charging process the target charge state is decreased during the next charging process by a predefined value. When the charge state of an electrochemical cell falls below the target charge state after a charging process, the charge current and/or the charge time for this electrochemical cell is increased during the next charging process by a predefined value. In this way, it is particularly simple to suit the charge currents or the charge times of the individual cells to their charging behavior.

According to a particularly preferred embodiment, the predefined value to increase or decrease the charge current and/or the charge time is selected in dependence on an extent of the deviation of the charge state of the respective cell from the target charge state. In this way, the adjustment during the next charging operation cannot cause a deviation from the target charge state in the reverse direction. It is hereby particularly useful to select the predefined value proportional to the extent of the deviation from the target charge state. The closer an electrochemical cell of the battery is thus to its target charge state after a charging process, the lesser the need for a correction of the charge current or the charge time for this electrochemical cell during the next charging process. Of course, a selection of substantially any appropriate functions is possible which define a correlation between the extent of the deviation from the target charge state and the resultant correction.

The invention and its embodiments will now be explained in greater detail with reference to the drawing. The sole FIGURE shows hereby a schematic illustration of a battery of a motor vehicle for carrying out an exemplary embodiment of the method according to the invention.

A battery, generally designated by 10 for an electrically driven motor vehicle includes a plurality of electrochemical cells 12 which are connected in series with one another in the shown example. Each cell 12 is associated to a monitoring and control unit 14 by which operating parameters of the electrochemical cell 12, such as for example its terminal voltage, temperature, or the like, can be checked. When the battery is charged, the monitoring and control unit 14 can be used to also set for each electrochemical cell a specific charge current or a specific charge time. The monitoring and control units 14 communicate with a battery controller 16 which is intended for monitoring and control of all operating parameters of the battery 10.

Due to manufacturing tolerances and aging effects, the individual chemical cells 12 of the battery 10 differ in their electrical storage capacity. When charging all electrochemical cells 12 during charging of the battery 10 under the same conditions, for example with same charge current and charge times, the differences between the electrochemical cells 12 cause different charge states in the individual cells 12. This is undesirable because this leads for example to uneven loads across the individual electrochemical cells 12 of the battery 10. Individual cells 12 may hereby, for example, age faster so that the life of the battery 10 decreases overall.

For this reason, charging of the battery 10 is usually followed by a so-called balancing of the electrochemical cells 12. The charge states of the individual cells 12 are hereby compared with respective target values. When individual electrochemical cells 12 are charged more than wanted, they are discharged again by a corresponding amount. Cells 12 that are inadequately charged are however being charged further until they reach the desired charge state. Ideally, the electrical energy stored in the excessively charged electrochemical cells 12 is used to further charge insufficiently charged electrochemical cells. 12. This process can be controlled by the monitoring and control units 14. Such a balancing of the electrochemical cells 12, however, increases in a disadvantageous manner the overall duration for charging the battery 10. At the same time, individual cells 12 may be overloaded to such an extent that they become damaged.

It is therefore desirable and useful to combine balancing of the electrochemical cells 12 directly with the charging process. For this purpose, when charging 10 for the first time, a predefined charge current and a predefined charge time is set for each electrochemical cell 12. These currents and times are hereby the same for all electrochemical cells 12. After charging, the charge states of the individual cells 12 are typically measured by the monitoring and control units 14 and balancing is carried out. The individual charge states are transmitted by the monitoring and control units to the battery controller 16 and stored there. During subsequent charging processes, the charge currents and charge times for the individual electrochemical cells 12 are adjusted based on the determined charge states after first-time charging. Electrochemical cells 12 which have been charged excessively after the first-time charging are charged during the following charging processes to a lesser degree by either reducing the charge current and/or decreasing the charge time. Electrochemical cells 12 which have been charged insufficiently during first-time charging are, however, charged to a greater degree during subsequent charging processes by increasing the charge current or prolonging the charge time. This adjustment of the charge currents and charge times eliminates the need for a separate balancing.

As physical properties of the electrochemical cell 12 change with increasing age, it is useful to periodically check as to whether the used charge times and charge currents for the electrochemical cell 12 still produce the desired result. This can be carried out after each charging process. In a same manner as after the first-time charging process, the monitoring and control units 14 determine the charge states of the respectively associated electrochemical cells 12, determine deviations from a target charge state and transmit the deviations to the battery controller 16, and finally balancing is carried out when the deviations are excessive. The battery controller 16 now determines new corrected charge times and charge currents for all electrochemical cells 12 on the basis of the measured deviations from the target charge state. The extent of the decrease or increase of the charge time and charge currents can hereby be made dependent on the extent of the difference between the charge states of the electrochemical cells 12 and their target charge state. In the simplest case, there is a direct proportionality between the amount of correction of charge current and charge time and the deviation of the charge state from the target charge state. In this way, the charge current and the charge time can be optimized iteratively for each individual electrochemical cell 12 of the battery 10 so that the battery controller 16 learns to respectively charge the individual electrochemical cells 12 in an optimum manner to thereby completely eliminate the need for balancing phases and prevent overcharging of individual cells.

1.-7. (canceled)

8. A method for charging a battery of a motor vehicle, comprising:
charging all electrochemical cells of the battery with a predefined charge current for a predefined charge time when charging the battery for a first time;
determining a charge state of each of the electrochemical cells after charging the battery for the first time;
storing a deviation of the determined charge state of each of the electrochemical cells from a target charge state;
balancing the electrochemical cells; and
establishing for a recharging process for each of the electrochemical cells a charge current and/or charge time in dependence on the stored deviation from the target charge state.

9. The method of claim 8, further comprising determining the charge state of each of the electrochemical cells after the recharging process, storing for each of the electrochemical cells a deviation from the target charge state, and balancing the electrochemical cells.

10. The method of claim 9, further comprising establishing for each of the electrochemical cells the charge current or the charge time for any following recharging process in dependence on the stored deviation from the target charge state after a preceding recharging process.

11. The method of claim 8, further comprising decreasing the charge current or the charge time by a predefined value when the determined charge state of an electrochemical cell exceeds the target charge state after being charged.

12. The method of claim 11, wherein the predefined value is selected in dependence on an extent of the deviation of the charge state of the electrochemical cell from the target charge state.

13. The method of claim 12, wherein the predefined value is selected proportional to the extent of the deviation from the target charge state.

14. The method of claim 8, further comprising increasing the charge current or the charge time by a predefined value when the determined charge state of an electrochemical cell falls below the target charge state after being charged.

15. The method of claim 14, wherein the predefined value is selected in dependence on an extent of the deviation of the charge state of the electrochemical cell from the target charge state.

16. The method of claim 15, wherein the predefined value is selected proportional to the extent of the deviation from the target charge state.
